(19) United States
(12) Patent Application Publication
(10) Pub. No.: US 2008/0082196 A1
(43) Pub. Date: Apr. 3, 2008

(54) Manufacturing System and Method

(76) Inventors: Gregory S. Wiese, Wayland, MA (US); Suresh R. Nair, Amherst, NH (US)

Correspondence Address: ROCKWELL AUTOMATION, INC. / WHD;ATTENTION: SUSAN M. DONAHUE, PATENT DEPT. / E-7F19, 1201 SOUTH SECOND STREET, MILWAUKEE, WI, 53204, US

(21) Appl. No.: 11/537,038

(22) Filed: Sep. 29, 2006

(51) Int. Cl. G06F 19/00

(52) U.S. Cl. 700/110; 700/212

(57) ABSTRACT

An automated manufacturing system, intermediate control device for implementation in such a system, and method of performing a manufacturing operation are disclosed. In at least some embodiments, the automated manufacturing system includes a first sensor that provides a first output signal, a first controllable device, and a first process controller capable of issuing a first command to the first controllable device. The system further includes a first intermediate control device coupled between the first sensor and the first process controller. The first intermediate control device receives the first output signal and determines, based at least in part upon the first output signal, whether to send an additional signal to the first process controller indicative of a failure condition.

### CROSS-REFERENCE TO RELATED APPLICATIONS

### STATEMENT REGARDING FEDERALLY SPONSORED RESEARCH OR DEVELOPMENT

### FIELD OF THE INVENTION

The present invention relates to control and/or monitoring systems, and more particularly to systems employed in controlling and/or monitoring manufacturing processes.

### BACKGROUND OF THE INVENTION

Many modern manufacturing processes are automated to a high degree. In order for automated manufacturing processes to operate predictably and reliably, the systems used to perform such processes (“automated manufacturing systems”) often employ numerous sensors that are capable of sensing a variety of different components, conditions and/or parameters. Often, multiple sensors are employed collectively in relation to a single step of the manufacturing process.

Conventional sensors often have complicated designs that allow the sensors to achieve high accuracy and reliability, and to perform a variety of functions. For example, many conventional sensors include not only sensing components, but also include various other circuitry such as power management circuitry, output switching circuitry and/or electrical protection circuitry. Although the accuracy and reliability of today's sensors is often quite high, the performance of such sensors can still be adversely affected when the sensors are exposed to the stresses of a manufacturing process, for example, high or low temperatures, high or rapid temperature fluctuations, physical impacts or impulses, or high-energy electromagnetic fields as are generated in some manufacturing processes, such as those associated with automotive welding operations.

In the context of ferrite-core inductive sensors in particular, such sensors typically are unable to operate in the presence of high-energy electromagnetic fields such as those created during welding operations, due to saturation of the ferrite cores in the sensors. While some inductive proximity sensors termed “weld field immune” (WFI) sensors have been designed to operate during the presence of high-energy electromagnetic fields, such sensors have sensing ranges that are limited. Consequently, to achieve desired sensing operation, users need to mount such sensors close to the sensors' targets. This, however, tends to increase the likelihood that the sensors will be damaged over time due to exposure to various physical hazards, for example, due to impacts from components undergoing manufacturing (e.g., an auto body) or contact with damaging materials during a manufacturing process (e.g., weld slag hitting the sensor).

Given their complexity, the sensors employed in automated manufacturing systems can be expensive. Therefore, as the multiple sensors employed in an automated manufacturing system occasionally malfunction or break over time due to their repeated exposure to manufacturing-related stresses, the costs associated with the replacement or repair of sensors can become undesirably high. Yet even more disadvantageous than the costs of replacing or fixing damaged sensors in an automated manufacturing system is the fact that, when sensors become damaged, the sensors often will no longer provide appropriate output signals, which can disrupt the operation of the entire system (or at least a significant portion of the system) and/or cause significant delays in the performance of the automated manufacturing process.

In particular, in many conventional automated manufacturing systems, a controller such as a programmable logic controller is implemented so as to control the process, or at least to control a portion of the process. The controller typically is both in communication with one or more controllable devices (e.g., a welding device) and also in direct communication with several sensors. In such systems, the controller is commonly programmed to cause a manufacturing process to continue so long as no improper signals are received from any of the sensors with which the controller is communicating. However, once a signal that is contradictory to an expected state is received from any one or more of the sensors, the controller typically will cause the process under its control to stop. Consequently, repeated process stoppages can occur as one or more of the sensors malfunction or break, which in turn can result in delays that significantly reduce the efficiency and output of the process.

For at least these reasons, therefore, it would be advantageous if an improved automated manufacturing system, and/or component(s) thereof, and/or related method of conducting an automated manufacturing process could be developed, where operation of the system, component(s), and/or process was less susceptible to problems arising from the exposure of one or more sensors to manufacturing-related stresses. More particularly, it would be advantageous if, in at least some embodiments, such an improved automated manufacturing system could be operated with less chronic costs associated with the replacement and/or fixing of sensor(s) employed by the system. Further, it would be advantageous if, in at least some embodiments, the frequency of process stoppages precipitated by sensor malfunctions in such an improved automated manufacturing system could be reduced, so as to result in a system having enhanced efficiency and/or productivity relative to conventional automated manufacturing systems.

### BRIEF SUMMARY OF THE INVENTION

The present inventors have recognized that an improved automated manufacturing system employing one or more process controllers can be achieved by providing an additional intermediate control device that is coupled between at least one of the process controllers and one or more sensors of the automated manufacturing system. In at least some embodiments, the intermediate control device is physically positioned sufficiently remotely from one or more sources of manufacturing-related stresses such that the intermediate control device is substantially less likely to suffer damage than the sensors, which are positioned more closely to the sources of manufacturing-related stresses.

Additionally, in at least some embodiments, the intermediate control device includes circuitry and/or functionality that in conventional automated manufacturing systems is included/performed within the sensors of the automated manufacturing system. Further, in at least some embodiments, the intermediate control device includes fault management circuitry or software (for example, weld field immunity management circuitry or software) that determines, or assists in determining, whether a given fault or improper/unexpected output received from a sensor is indicative of a problem that should precipitate the automated manufacturing system, or one or more of the process controllers in particular, to stop/delay operation of the automated manufacturing process.

More particularly, in at least some embodiments, the present invention relates to an automated manufacturing system that includes a first sensor that provides a first output signal, a first controllable device, and a first process controller capable of issuing a first command to the first controllable device. The automated manufacturing system further includes a first intermediate control device coupled between the first sensor and the first process controller. The first intermediate control device receives the first output signal and determines, based at least in part upon the first output signal, whether to send an additional signal to the first process controller indicative of a failure condition.

Additionally, in at least some embodiments, the present invention relates to an intermediate control device for implementation in an automated manufacturing system. The intermediate control device includes a plurality of input terminals capable of being coupled to a plurality of sensors and receiving a plurality of sensor signals therefrom, and a first output terminal capable of being coupled to a programmable logic controller and sending an output signal thereto. The intermediate control device also includes a processing component capable of determining whether to send the output signal based at least in part upon at least one of the sensor signals, the output signal indicating a failure of at least one of the plurality of sensors.

Further, in at least some embodiments, the present invention relates to a method of performing a manufacturing operation. The method includes sensing a presence of a component at a sensor, conducting a manufacturing operation that is capable of effecting a stress on the sensor. The method additionally includes determining whether an output signal from the sensor has taken on a characteristic indicative of a failure of the sensor and, if it is determined that the output signal has taken on the characteristic, sending an output signal to a controller.

### BRIEF DESCRIPTION OF THE DRAWINGS

FIG. 1 is a schematic view of an exemplary, improved automated control system being employed to perform a welding process, in accordance with at least some embodiments of the present invention;

FIG. 2 shows in schematic form internal components of an exemplary sensor capable of being employed in the automated control system of FIG. 1;

FIG. 3 shows in schematic form internal components of an exemplary intermediate control device capable of being employed in the automated control system of FIG. 1; and

FIG. 4 is a flow chart illustrating exemplary steps of operation of the automated control system of FIG. 1 in performing operations of an exemplary manufacturing process, in accordance with at least some embodiments of the present invention.

### DETAILED DESCRIPTION OF THE PREFERRED EMBODIMENT

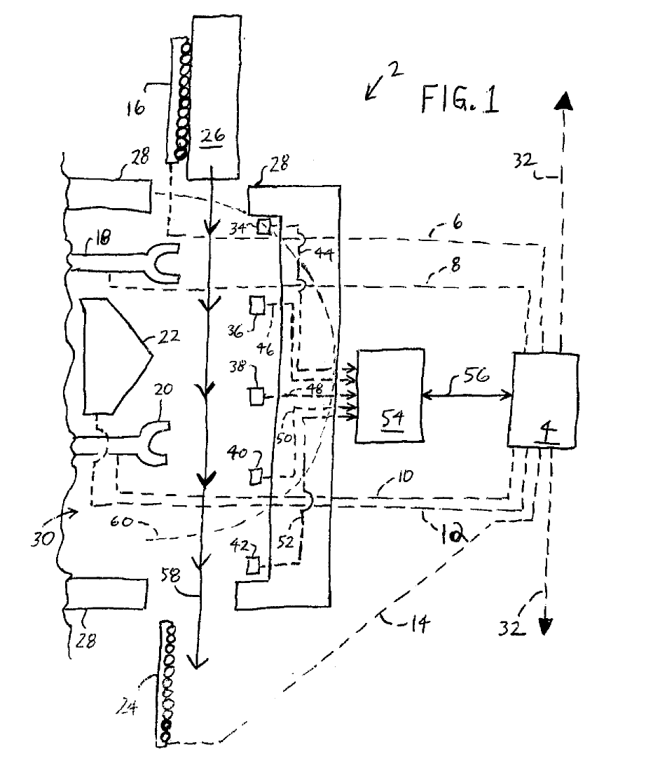

Referring to FIG. 1, an exemplary automated manufacturing system 2 in accordance with at least one embodiment of the present invention is shown in schematic form. The automated manufacturing system 2 performs an automated manufacturing process, which in the present embodiment is a welding process such as that employed during the manufacture of automobiles, as described in further detail below with reference to FIG. 4. Thus, in the present embodiment, the automated manufacturing system 2 is an automotive welding system or a portion of such a system. Depending upon the embodiment, the automated manufacturing system 2 that is shown in FIG. 1 can constitute only a subportion of a larger system. For example, the welding operation performed by the system 2 can be only one of multiple welding operations that are performed upon a variety of automotive components that are being assembled with one another. Thus, it should be understood that the automated manufacturing system 2 is intended to be representative of a variety of systems and subsystems that can be used for performing a variety of manufacturing steps and operations in a variety of industrial and other environments.

The automated manufacturing system 2 is an automated system insofar as it includes at least one process controller that governs the operation of the manufacturing process, or at least a portion of the process, and more particularly governs the operation of one or more controllable devices that are active in performing the process. In the present embodiment, the automated manufacturing system 2 in particular includes a process controller 4 that is a programmable logic controller (PLC) such as one of the ControlLogix PLCs available from Rockwell Automation, Inc. of Milwaukee, Wis. As shown, the process controller 4 is capable of controlling several controllable devices within the automated manufacturing system 2. In particular, the process controller 4 is in communication with, by way of first, second, third, fourth and fifth communication links 6, 8, 10, 12 and 14, respectively, a first moving device 16, a first clamping device 18, a second clamping device 20, a welding device 22, and a second moving device 24.

By way of the communication links 6-14, the process controller 4 is able to control the operation of the devices 16-24 to perform a welding process such as that described in accordance with FIG. 4. More particularly, by controlling the first moving device 16, the process controller 4 is able to cause a target item 26 to move into a welding room 30 that is formed/surrounded by several walls 28. Once the target item 26 is positioned within the room 30, it is clamped into a desired position by way of the first and second clamping devices 18 and 20 as controlled by the process controller 4, and subsequently the process controller causes the welding device 22 to perform a welding operation on the target item 26 (although not shown, the welding operation could involve welding an additional item onto the target item). Once the welding operation is complete, the clamping devices 18, 20 are controlled by the process controller 4 to release the target item 26 and the process controller 4 is then able to cause the target item to be moved out of the room 30 by way of the second moving device 24. In the present embodiment, the target item 26 is intended to be representative of any of a variety of structures or components that could be welded, for example, a portion of an automobile frame.

The automated manufacturing system 2 shown in FIG. 1 is intended to be exemplary of a wide variety of different manufacturing systems and subsystems that can be used in a variety of industrial and other circumstances to perform a variety of different processes. Therefore, while the present automated manufacturing system 2 is shown to include the first and second moving devices 16, 24 and the first and second clamping devices 18, 20, the present invention is intended to encompass a variety of systems that employ devices other than or in addition to those moving devices and clamping devices. Likewise, while the presently-described system includes the welding device 22 for performing welding operations upon items such as the target item 26, the present invention is intended to encompass automated manufacturing systems that employ more than one welding device or systems that employ no welding devices.

In alternate embodiments, for example, the automated manufacturing system could employ devices for performing operations other than (or in addition to) a welding operation including, for example, heating or cooling operations, painting or spraying operations, various physical operations such as pushing components together or pulling components apart from one another, bending components, applying torques or other types of forces (e.g., shearing forces) upon components, connecting or fastening components together, and a variety of other operations. It should further be mentioned that the process controller 4 in the present embodiment is designed to be capable of interaction with other programmable logic controllers or other process controllers (not shown) by way of one or more networks or other communication links 32, which could be, for example, DeviceNet or ControlNet networks. Thus, the automated manufacturing system 2 of FIG. 1 is capable of coordinated operation with other automated manufacturing systems or subsystems governed by other controllers. Further, the automated manufacturing system 2 of FIG. 1 in at least some embodiments, by way of communication links 32 (or other links, which can be wired or wireless), is capable of communicating with still other devices. In at least some such embodiments, these devices are computerized devices including, for example, computer terminals that are remotely located away from the process controller. Additionally, in some such embodiments, the communications can occur via the internet.

Further as shown in FIG. 1, the automated manufacturing system 2 has at least one sensor and in the present embodiment in particular has five sensors, namely, a first sensor 34, a second sensor 36, a third sensor 38, a fourth sensor 40, and a fifth sensor 42. Additionally, the automated manufacturing system 2 includes an intermediate control device or intermediate controller 54, which can in at least some embodiments be termed a “tool-based controller”. Each of the sensors 34-42 is coupled to the intermediate controller 54 by way of a respective one of five hardwired communication links, namely, a first communication link 44, a second communication link 46, a third communication link 48, a fourth communication link 50, and a fifth communication link 52, respectively. The intermediate controller 54 is additionally coupled to the process controller 4 by way of an additional hardwired communication link or network 56. The sensors 34-42 thus are connected only indirectly with the process controller 4, by way of the intermediate controller 54.

As shown, the sensors 34-42 typically are positioned close to a path 58 along which the target item 26 travels as it is moved into the room 30 for the welding operation and subsequently moved out of the room. That is, each of the sensors 34-42 is positioned proximate to the target item 26 as it proceeds through the room 30 and at least some of the sensors are positioned close to a location at which a welding operation performed by the welding device 22 occurs in relation to the target item 26. For this reason, the sensors 34-42 are likely to be exposed to repeated stresses over time as the automated manufacturing system 2 operates with respect to the target item 26 and other target items. In particular, the sensors 34-40 are situated within a substantially circular region demarcated by a dashed line 60 in which relatively high-energy electromagnetic fields occur due to operation of the welding device 22 during the welding operation (albeit the sensor 42 is located somewhat outside this region). Further, one or more of the sensors 34-42 also are likely to be exposed to other stresses during the manufacturing process including, for example, temperature-related stresses, physical impulse or impact-related stresses, and stresses related to exposure to various chemicals.

Although the sensors 34-42 are likely to be exposed to various stresses during manufacturing, this is in contrast to the intermediate controller 54, which is located sufficiently far away from the welding device 22 and, indeed, is located outside of the room 30 and on the opposite side of the wall 28 defining the room 30 relative to the sensors, such that the intermediate controller is not exposed to the same degree of stresses. In particular, as illustrated by the dashed line 60, the intermediate controller 54 is located outside the region in which there are relatively high-energy electromagnetic fields during the welding operation. The dashed line 60 can be understood as demarcating an inner region extending from the welding device 22 up to points at which the electromagnetic field intensity is 10% or less than a maximum level generated by the welding device 22 (in at least some embodiments, the radius of this region could be 12 inches). Thus, in the present embodiment the intermediate controller 54 is located in a region where the electromagnetic field intensity is 10% or less than a maximum generated by the welding device 22.

Further as shown, in the present embodiment the intermediate controller 54 not only is positioned so that it is less likely to be exposed to high-energy electromagnetic fields than some or all of the sensors 34-42, but also is positioned so that it experiences (or is likely to experience) less stresses of other types including, for example, high heat intensities and potentially-damaging physical impacts or impulses, to name a few. Thus, the present invention is intended to encompass a variety of embodiments in which one or more sensors are located in positions where those sensors are potentially subject to moderate or high stress levels of one or more types and at the same time are coupled to an intermediate control device (or possibly multiple intermediate control devices) that is located in a position at which it is less likely to be subject to those same types of stresses. The types of stresses to which the sensors, but not the intermediate control device(s), are significantly subjected can include not only those associated with exposure to high-energy electromagnetic fields, high temperatures, or physical impacts or impulses, but also other types of stresses such as those associated with extreme low temperatures, great or rapid temperature fluctuations, high (or low) pressures, or centrifugal forces.

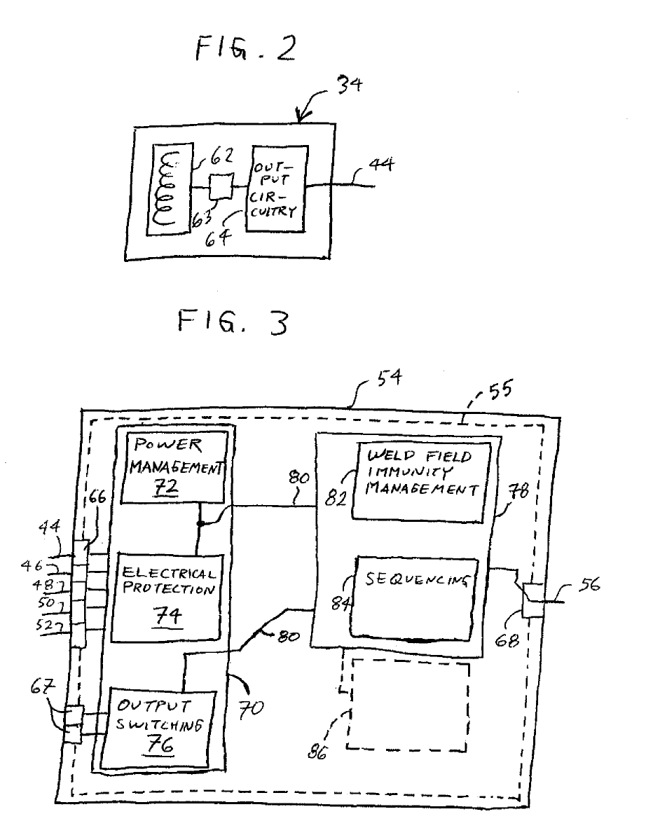

Referring additionally to FIG. 2, in contrast to many conventional sensors, the sensors 34-42 employed in the present automated manufacturing system 2 have a relatively simple form that minimizes the number and/or types of circuitry that are employed in the sensors. In particular as shown in FIG. 2, the sensor 34, which is representative of each of the sensors 34-42, is limited to a sensing component 62, logic circuitry 63, and an output circuit 64, which can be coupled to one another in series as shown. The output circuit 64 is employed to convert an output signal from the sensing component 62 as processed or modified by the logic circuitry 63 into a digital (or, in alternative embodiments, analog) signal that is suitable for transmission to the intermediate controller 54 by way of the communication link 44. In the embodiment of FIG. 2, the sensing component 62 is a coil, the output circuit 64 includes a tank circuit, and the sensor 34 is an inductive sensor. In some alternate embodiments, the output signal from the sensing component 62 can be provided directly to the output circuit 64, and the additional logic circuitry 63 is not required.

In alternate embodiments, the sensor 34 (and the other sensors 36-42) can be any of a variety of types of sensors having an appropriate sensing component (or components) and output circuit (or circuits) including, for example, a photoelectric sensor, a photosensor, a magnetic sensor, a laser sensor, a pressure sensor, a temperature sensor, a vibration sensor, a proximity sensor, a position sensor, a flow sensor, an ultrasonic sensor, a capacitive sensor, a RF sensor, a humidity sensor, a transducer and/or a variety of other types of sensors, including a variety of other types of condition sensors. Also, while the sensor 34 of FIG. 2 includes the output circuit 64, in at least some embodiments the sensing component 62 is capable of providing a signal directly that is suitable for output via the communication link 44. Although not shown in FIG. 2, the sensors 34-42 can include housings or outer walls that provide some shielding/protection of the sensors' internal components from electromagnetic radiation, heat and/or other sources of stress that can potentially result in damage to the sensors.

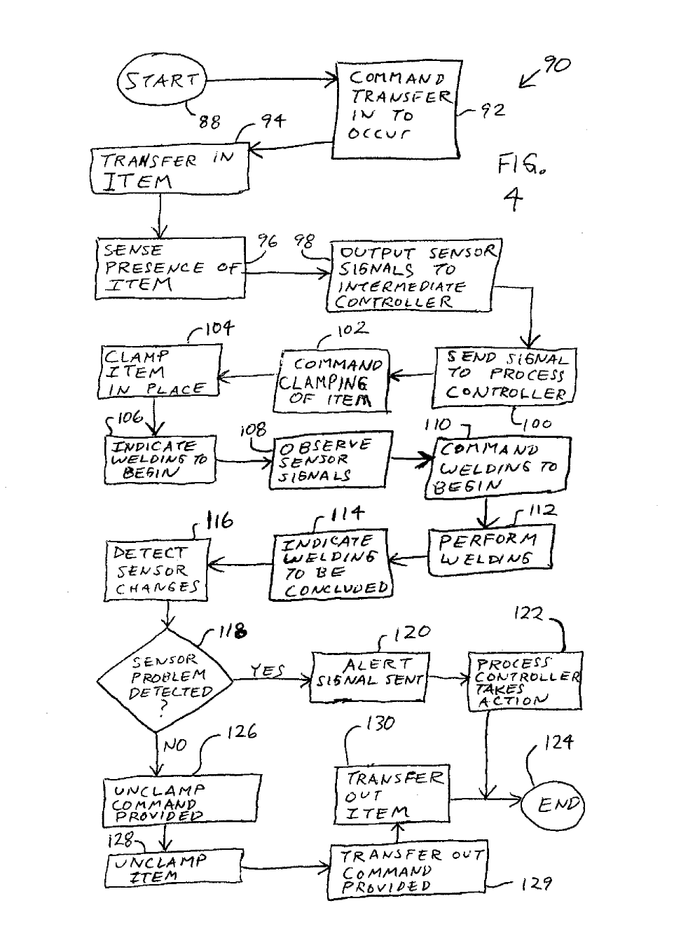

While the sensors 34-42, in contrast to conventional sensors, employ only minimal components/circuits, much of the circuitry that ordinarily is provided in conventional sensors instead is provided as part of the intermediate controller 54. Referring to FIG. 3 in particular, the intermediate controller 54 in the present embodiment not only includes a plurality of input ports 66 by which the intermediate controller is coupled to the communication links 44-52 (and thereby to the sensors 34-42) and an output port 68 by which the intermediate controller 54 is coupled to the additional communication link 56 (and thereby to the process controller 4), but also includes several types of circuitry 70 that ordinarily would be included within the sensors, as well as several additional output ports 67. More particularly, in the present embodiment, the circuitry 70 includes power management circuitry 72, for example, voltage supply circuitry. Also, the circuitry 70 includes electrical protection circuitry 74, such as short circuit overload protection circuitry and reverse polarity circuitry.

Further, the circuitry 70 includes output switching circuitry 76, for example, maximum current circuitry. The output switching circuitry 76 in particular as shown is coupled to the additional output ports 67. The output switching circuitry 76 by way of the output ports 67 (as well as external communication link(s), not shown) is thus capable of providing control signals or other signals to controlled devices (e.g., valves, motors, relays, etc.) as well as to other devices, including devices that provide additional monitoring or control functions (e.g., remote computer terminals). In some alternate embodiments, the output switching circuitry 76 can include (or be replaced with) additional circuitry allowing for the input of additional signals into the intermediate controller 54, that is, the output switching circuitry can be replaced with circuitry capable of both input and output functionality (or merely input functionality).

In addition to including the circuitry 70, the intermediate controller 54 additionally as shown in FIG. 3 typically includes a processing device 78 that controls overall operation of the intermediate controller 54 and in particular can be coupled as shown to each of the types of circuitry 70 by one or more internal buses 80, so as to allow for control and/or monitoring of that circuitry. The processing device 78 can be any of a number of different types of computerized devices, processors, or other processing circuitry including, for example, a microprocessor. The processing device 78 can include and operate based upon a variety of different software or other programming, including software governing how the processing device 78 interacts with and controls the circuitry 70.

Additionally, the processing device 78 includes fault management software, which in the present embodiment is shown as weld field immunity management software 82. The weld field immunity management software 82 enables the processing device 78 to monitor the signals received from the sensors 34-42 by way of the communication links 44-52 (which, in at least some embodiments such as the present embodiment, are hardwired links that do not employ any protocol) and to make determinations based upon those signals as to whether one or more of those sensors have experienced a fault or failure that is severe enough so as to warrant a change in the automated manufacturing process being controlled by the process controller 4. Depending upon the particular determinations that are made by way of the weld field immunity management software 82, the processing device 78 in turn provides signals via the additional communication link 56 to the process controller 4, in response to which the process controller 4 can take various actions such as causing a modification of the automated manufacturing process or even a complete cessation of the automated manufacturing process.

The weld field immunity management software 82 can make a variety of determinations, in a variety of manners, depending upon the particular embodiment. In at least some embodiments, the weld field immunity management software 82 determines whether a given one of the sensors 34-42 has experienced an unacceptable failure as follows. First, when a welding operation is about to begin, the process controller 4 sends a signal to the intermediate controller 54 by way of the additional communication link 56 indicating this to be the case. The intermediate controller 54 at that time observes/records the signals that are being provided from the sensors 34-42. The signals that are being provided in at least some such embodiments are merely indicative of the presence or absence (or proper positioning) of a target item such as the target item 26 that is to be the subject of the welding operation.

Subsequently, after the welding operation has been performed, the process controller 4 again sends a signal to the intermediate controller 54 indicating that the welding operation has been completed, and in response the intermediate controller 54 again observes/records the signals that are being provided from the sensors. If a sensor signal has changed sufficiently in its value/level relative to its value/level prior to the welding operation, then this potentially is indicative of a failure of the sensor. In some cases, merely the occurrence of such a change would be sufficient basis for a determination by the weld field immunity management software 82 that an unacceptable failure has occurred. In other, more preferred, embodiments, the weld field immunity management software 82 is configured to determine that a sensor failure has occurred based upon not only whether an inappropriate sensor signal value has appeared but also whether that inappropriate sensor signal value continues to occur for a threshold length of time after the welding operation has been performed, for example, for more than a single weld cycle (e.g., approximately 1 second).

Typically, if the weld field immunity management software 82 determines that any one or more of the sensors 34-42 have experienced a failure, the processing device 78 sends a signal to the process controller 4 that causes a complete cessation of the automated manufacturing process. However, in some alternate embodiments it can instead be the case that the processing device 78 will only send a signal to the process controller 4 precipitating a shutdown if the weld field immunity management software 82 determines that more than one of the sensors 34-42 (or even a majority of those sensors) have experienced a failure. Further, in some alternate embodiments, the particular signal output by the processing device 78 will vary depending upon the particular failure circumstance.

For example, the sensor 40 of FIG. 1 is proximate the second clamping device 20 and can sense the presence of an item such as the target item 26 held in position by that clamping device. Assuming that the second clamping device 20 is redundant in relation to the first clamping device 18, and that sensing the presence of an item at the second clamping device by way of the sensor 40 is redundant in view of the sensing of the presence of the item at the first clamping device 18 by way of (for example) the sensor 36, the automated manufacturing system 2 is still capable of proper operation notwithstanding a failure of the sensor 40. Thus, in such embodiment, the weld field immunity management software 82 can ignore a failure of the sensor 40 so long as a failure has not occurred with respect to the sensor 36. Further, in circumstances where only the sensor 40 has failed (but the sensor 36 has not failed), the weld field immunity management software 82 can cause the processing device 78 to send a modified failure signal to the process controller 4 in response to which, rather than causing a complete cessation of the automated manufacturing process, the process controller 4 merely outputs or otherwise provides a warning indication that the sensor 40 needs replacement.

Because the intermediate controller 54 includes the circuitry 70 that previously would be positioned within the discrete sensors 34-42, the sensors 34-42 themselves have less (or at least different) componentry. Removal of the features such as weld field immunity management software 82 and/or related circuitry from the sensors can allow for the sensors themselves to be reduced in size or allow for a same-sized sensor to have available additional room for other sensor features. Such other features can include, for example, additional structures allowing for improved sensing techniques to be implemented, such as techniques that allow for increased sensing ranges, as well as additional structures that improve the durability of the sensing packages, for example, metal face sensors. Such features can make it possible to mount the sensors farther away from the target(s) they are sensing, such that the sensors are less susceptible to physical damage during the manufacturing process. For that reason, in comparison with conventional sensors, the sensors 34-42 are less susceptible to damage due to stresses such as heat-related stresses or physical impact stresses. Further, when the sensors do need to be replaced or repaired, the cost of repairing or replacing the sensors is reduced relative to what it ordinarily would be in a conventional system. Likewise, although not all conventional sensors have circuitry that determines (or assists in determining) whether the sensors have experienced failures, to the extent that some conventional sensors do have such circuitry, the inclusion of the weld field immunity management software 82 within the processing device 78 of the intermediate controller 54 eliminates the need for such circuitry in the sensors and so, for that reason as well, the sensors 34-42 can be less susceptible to damage and, when damage does occur, the sensors can be repaired or replaced at relatively less cost than conventional sensors.

It should further be mentioned that, while the intermediate controller 54 (unlike the sensors 34-42) in the present embodiment is desirably positioned sufficiently far away from heat, physically moving items, chemicals, and/or other potential manufacturing-related hazards or sources of stress that could potentially damage its internal circuitry and/or other components so as to largely if not completely eliminate the risk of damage to its internal components, this does not mean that in all embodiments the intermediate controller is positioned so far away as to remove all risk of damage. Rather, the present invention is also intended to encompass embodiments in which the intermediate controller is largely removed away from the hazards/sources of stress but yet there remains some risk that damage could occur. In at least some such embodiments, as indicated by a dashed line 55 shown in FIG. 3, the intermediate controller 54 includes a housing or wall that provides shielding to afford additional protection to the internal components of the intermediate controller against heat, physically moving items, chemicals and/or some of the other hazards/sources of stress that can result in damage to the sensors and also could potentially damage the intermediate controller.

Although FIG. 3 shows the processing device 78 as including the weld field immunity management software 82, as mentioned above the weld field immunity management software is only one example of various fault management software that can be employed by a processing device to make determinations as to whether particular failures or faults have occurred and as to what types of actions should be taken in response to such determinations (e.g., what types of signals should be sent to a controller such as the process controller 4). The term “weld field immunity management” is employed in the present example since the automated manufacturing process performed by the automated manufacturing system 2 involves welding involving the generation of electromagnetic fields; however, where other operations such as heating or cooling operations, painting operations, drilling operations or other physical operations are performed by a given automated manufacturing system, a different term could be used to refer to the software employed in the processing device for determining the occurrence of faults. Further, in some embodiments, the implementation of such fault management/detection functionality is performed not by way of software implemented on a processing device such as the processing device 78, but rather is implemented by way of other circuitry on the intermediate controller 54.

In addition to the circuitry 70 and the weld field immunity management software 82 employed in the processing device 78 shown in FIG. 3, depending upon the embodiment the intermediate controller 54 can encompass various additional types of circuitry and/or software as well. For example, in the embodiment of FIG. 3 the processing device 78 also includes sequencing software 84, which ascertains whether target items have been put in (or are passing through) the automated manufacturing system 2 in the correct order. If the target items have not been put in the correct order, then the processing device 78 can send a signal indicative of that fact to the process controller 4 by way of the additional communication link 56. By identifying and ensuring proper sequencing of parts, the amount of waste/scrap generated by the manufacturing process can be reduced, and there is typically less down-time due to errors. In particular, by performing these operations early on in a manufacturing process (e.g., so as to find errors, reject problem parts, or otherwise control the process early on), manufacturing efficiency can be enhanced.

Also for example, in various embodiments the intermediate controller 54 can include additional circuitry as represented by a box 86. In at least some embodiments, the intermediate controller 54 is coupled to the sensors 34-42 by way of a wireless communication network/wireless communication links rather than by way of hardwired communication links as are represented by the communication links 44-52. In such embodiments, the additional circuitry represented by the box 86 can be a wireless transceiver controlled by the processing device 78. Also in such embodiments, the output circuitry of the sensors such as the output circuit 64 of FIG. 2 can also include corresponding transceivers or at least transmitters for sending sensor output signals. In still further embodiments, the intermediate controller 54 is also coupled to the process controller 4 by way of a wireless communication link rather than the hardwired communication link 56, in which case both the intermediate controller 54 and the process controller 4 include wireless transceivers.

Turning to FIG. 4, a flow chart 90 is provided showing exemplary steps of operation of a welding process performed by the automated manufacturing system 2 of FIG. 1. It will be understood that the steps of operation shown are only intended to be one example of operational steps that can be performed by an automated manufacturing system that in particular is designed to perform welding operations. Thus, notwithstanding FIG. 4, the present invention is also intended to encompass a variety of other welding-related processes and other manufacturing processes (including those unrelated to welding) that involve the performance of additional or fewer steps, or different steps, as are appropriate depending upon the particular automated manufacturing system or process that is of interest.

In the present embodiment, upon starting the process 90 at a step 88, the process controller 4 provides a command to the first moving device 16 to transfer in a target item such as the target item 26, at a step 92. Then, in response to the command, the moving device 16 transfers in the target item, at a step 94. Next, at a step 96, the sensors 34-42 (or at least a subset of those sensors) detect the presence of the target item within the room 30 and further, at a step 98, the sensors output signals indicative of that presence to the intermediate controller 54, which in turn causes the intermediate controller 54 to send a signal indicating the presence of the target item to the process controller 4, at a step 100.

Upon receiving confirmation that the target item is present, the process controller 4 sends commands to the first and second clamping devices 18 and 20 to clamp the item in place, at a step 102, which subsequently results in the clamping devices taking such action at a step 104. Then, upon completion of the clamping at step 104, at a step 106 the process controller 4 then sends a signal to the intermediate controller 54 that welding is about to take place. At a step 108, the intermediate controller 54 then observes/records the present values of the sensor signals being received from the sensors 34-42. At a step 110, the process controller 4 next provides a command to the welding device 22 to commence the welding process and, at a step 112, the welding device 22 performs the welding upon the target item. The time during which the welding process occurs generally is a blackout period for the sensors 34-42, in which they are unable to properly operate, and the intermediate controller 54 does not make any determinations based upon the sensor signals it may receive during this time.

Once the welding is completed, at a step 114 the process controller 4 provides a signal to the intermediate controller 54 indicating this to be the case. In response, at a step 116 the intermediate controller 54 observes the values of the sensor signals occurring at that time and detects any changes that have occurred in those sensor signals since they were previously observed at step 108. The exact changes that are detected can depend upon the embodiment and, in some embodiments can be highly nuanced. For example, in at least some embodiments and as described above, the intermediate controller 54 detects in particular whether any changes in the sensor signals that are occurring immediately following the welding operation continue to occur for a threshold amount of time thereafter.

If, at a step 118, the intermediate controller 54 determines that a sensor failure has occurred based upon the detected changes, then an additional signal is provided from the intermediate controller to the process controller 4 alerting the process controller that the failure has occurred, at a step 120. Upon receiving the additional signal, the process controller 4 then takes appropriate action at a step 122, after which time the process ends at a step 124. The particular action that is taken again can be highly nuanced depending upon the embodiment or circumstance, albeit in at least some embodiments the action that is taken is simply the complete stopping of the automated manufacturing process. If, however, at step 118 the intermediate controller 54 does not determine that a sensor failure has occurred, then the process continues to completion. Thus, at a step 126, the process controller 4 provides a command to the clamping devices 18, 20 to unclamp the target item and, at a step 128, the item is unclamped by the clamping devices. Then, at a step 129, the process controller 4 provides a command to the second moving device 24 that the target item be transferred out and, at a step 130, the item is transferred out, after which time the process again is ended at the step 124.

Although FIGS. 1-4 show exemplary aspects of certain embodiments of the present invention, the present invention is intended to encompass a variety of embodiments other than those shown. As already mentioned above, the present invention is intended to encompass a variety of automated manufacturing systems and processes other than those that involve welding, and also is intended to encompass a variety of automated manufacturing systems that employ controllable devices (or sensors or other devices) other than, or in addition to, those shown in FIGS. 1-3. While in the embodiments described above the sensors 34-42 only provide output (sensory) signals to the intermediate controller 54 but at the same time the intermediate controller and the process controller 4 are able to communicate in either direction with one another by way of the additional communication link 56, in other embodiments other communications are also possible. For example, in some alternate embodiments, the intermediate controller is also capable of sending signals (including commands) to one or more of the sensors 34-42. Also, the weld field immunity management software 82 (or other software or circuitry relating to fault detection) employed in the processing device 78 (or elsewhere) can operate based upon a variety of different standards or test criteria. Even where faults are determined by observing whether inappropriate sensor signals continue for times exceeding a particular threshold, the threshold itself can be varied depending upon the circumstance, even during real-time operation of the system.

It is specifically intended that the present invention not be limited to the embodiments and illustrations contained herein, but include modified forms of those embodiments including portions of the embodiments and combinations of elements of different embodiments as come within the scope of the following claims.

We claim:

1. An automated manufacturing system comprising:
a first sensor that provides a first output signal;
a first controllable device;
a first process controller capable of issuing a first command to the first controllable device; and
a first intermediate control device coupled between the first sensor and the first process controller,
wherein the first intermediate control device receives the first output signal and determines, based at least in part upon the first output signal, whether to send an additional signal to the first process controller indicative of a failure condition.

2. The automated manufacturing system of claim 1, wherein the first controllable device is capable of generating a high intensity electromagnetic field, and
wherein the first sensor is located at a first position that is closer to the first controllable device than a second position at which is located the first intermediate control device.

3. The automated manufacturing system of claim 2, wherein a first intensity of the high intensity electromagnetic field at the second position is less than 10% of a maximum intensity of the high intensity electromagnetic field occurring at substantially that same time, and wherein the first intensity experienced at the first intermediate control device is substantially less than an additional intensity experienced by the first sensor at the first position.

4. The automated manufacturing system of claim 2, wherein the automated manufacturing system is configured to perform a welding operation and the first controllable device is a welding device.

5. The automated manufacturing system of claim 1 wherein the automated manufacturing system is an automotive welding system.

6. The automated manufacturing system of claim 1, further comprising a second controllable device, wherein the second controllable device is selected from the group consisting of a clamping device and a moving device.

7. The automated manufacturing system of claim 1, wherein the first intermediate control device includes a means for processing that determines whether to send the additional signal.

8. The automated manufacturing system of claim 1, wherein the first intermediate control device includes at least one of weld field immunity management circuitry and weld field immunity management software by which the first intermediate control device determines whether to send the additional signal.

9. The automated manufacturing system of claim 1, wherein the first intermediate control device determines whether to send the additional signal by determining whether the received first output signal remains at an inappropriate level for longer than a first time threshold.

10. The automated manufacturing system of claim 9, wherein the first time threshold is at least one of a length of a single weld cycle and approximately one second.

11. The automated manufacturing system of claim 1, wherein the first intermediate control device includes circuitry selected from the group consisting of power management circuitry, electrical protection circuitry, and output switching circuitry.

12. The automated manufacturing system of claim 1, wherein the first intermediate control device includes at least one of sequencing circuitry and sequencing software.

13. The automated manufacturing system of claim 1, wherein the first sensor does not include any of power management circuitry, electrical protection circuitry, and output switching circuitry, but does include a signal processing circuit capable of generating the first output signal.

14. The automated manufacturing system of claim 1, further comprising a second sensor that provides a second output signal, wherein the first intermediate control device receives the second output signal and determines, based at least in part upon both the first and second output signals, whether to send the additional signal.

15. The automated manufacturing system of claim 14, wherein the first intermediate control device determines that the additional signal should be sent if it is determined that both the first and second sensors have failed, and determines that an alternate, warning signal should be sent if it is determined that one of the first and second sensors has failed and the other of those sensors has not failed.

16. The automated manufacturing system of claim 1, wherein the first intermediate control device is coupled to the first sensor by one of a first wired connection and a first wireless connection.

17. The automated manufacturing system of claim 1, wherein the first process controller is a programmable logic controller (PLC).

18. The automated manufacturing system of claim 1, further comprising at least one of a second process controller and a computer that is coupled to the first process controller by way of a network.

19. The automated manufacturing system of claim 1, wherein the first sensor is selected from the group consisting of an inductive sensor, a photoelectric sensor, a photosensor, a magnetic sensor, a laser sensor, a pressure sensor, a temperature sensor, a vibration sensor, a proximity sensor, a position sensor, a flow sensor, an ultrasonic sensor, a capacitive sensor, a RF sensor, a humidity sensor, and a transducer.

20. The automated manufacturing system of claim 1, wherein the first sensor includes either both a sensing component and a signal processing component, or both a sensing component and a wireless transceiver.

21. The automated manufacturing system of claim 1, wherein the intermediate control device includes an electromagnetic radiation shielding structure.

22. An intermediate control device for implementation in an automated manufacturing system, the intermediate control device comprising:
a plurality of input terminals capable of being coupled to a plurality of sensors and receiving a plurality of sensor signals therefrom;
a first output terminal capable of being coupled to a programmable logic controller and sending an output signal thereto; and
a processing component capable of determining whether to send the output signal based at least in part upon at least one of the sensor signals, the output signal indicating a failure of at least one of the plurality of sensors.

23. The intermediate control device of claim 22, wherein the processing component determines whether to send the output signal based upon a determination that at least one of the sensor signals has taken on an abnormal value for longer than a first time threshold.

24. The intermediate control device of claim 23, wherein the first time threshold is a time period corresponding to a single weld cycle.

25. The intermediate control device of claim 22, wherein the processing component determines whether to send the output signal based upon a determination that more than one of the sensor signals have taken on abnormal values.

26. The intermediate control device of claim 22, wherein the intermediate control device includes circuitry selected from the group consisting of power management circuitry, electrical protection circuitry, and output switching circuitry.

27. The intermediate control device of claim 22, wherein the processing component is capable of conducting sequencing.

28. The intermediate control device of claim 22, further comprising an electromagnetic radiation shielding structure.

29. A method of performing a manufacturing operation, the method comprising:
sensing a presence of a component at a sensor;
conducting a manufacturing operation that is capable of effecting a stress on the sensor;
determining whether an output signal from the sensor has taken on a characteristic indicative of a failure of the sensor; and
if it is determined that the output signal has taken on the characteristic, sending an output signal to a controller.

30. The method of claim 29, wherein the manufacturing operation is a welding operation.

31. The method of claim 29, wherein the stress on the sensor involves at least one of exposure of the sensor to heat, exposure of the sensor to a chemical, and exposure of the sensor to a physical impulse or impact.

32. The method of claim 29, wherein the determining is performed by an intermediate control device coupled between the controller and the sensor.

33. The method of claim 32, wherein the controller is a programmable logic controller and the sensor is selected from the group consisting of an inductive sensor, a photoelectric sensor, a photosensor, a magnetic sensor, a laser sensor, a pressure sensor, a temperature sensor, a vibration sensor, a proximity sensor, a position sensor, a flow sensor, an ultrasonic sensor, a capacitive sensor, a RF sensor, a humidity sensor, and a transducer.

34. The method of claim 29, further comprising transporting a component into a region, and clamping the component within the region, prior to the conducting of the manufacturing operation.

35. The method of claim 34, further comprising declamping the component and moving the component out of the region, subsequent to the conducting of the manufacturing operation.

36. The method of claim 35, wherein the transporting, clamping, conducting, declamping and moving are all controlled by the controller.

37. The method of claim 29, wherein it is determined that the output signal has taken on the characteristic if the output signal takes on an inappropriate value for longer than a single weld cycle.
